(19) United States
(12) Patent Application Publication
(10) Pub. No.: US 2026/0323430 A1
(43) Pub. Date: Oct. 15, 2026

(54) TRAINING A MACHINE LEARNING MODEL WITH VENUE AWARENESS FOR HANDOVER PREDICTIONS

(71) Applicant: Cisco Technology, Inc., San Jose, CA (US)

(72) Inventors: Srinath Gundavelli, San Jose, CA (US); Matthew Stephen MacPherson, Cary, NC (US); Bahador Amiri, Saratoga, CA (US)

(21) Appl. No.: 19/246,060

(22) Filed: Jun. 23, 2025

Related U.S. Application Data
(60) Provisional application No. 63/785,815, filed on Apr. 9, 2025.

(51) Int. Cl. H04W 36/00; H04W 36/32; H04W 36/36; H04W 84/12

(52) U.S. Cl. CPC H04W 36/008375; H04W 36/324; H04W 36/362; H04W 84/12

(57) ABSTRACT

A machine learning model is trained using information associated with a layout of a venue, locations of a plurality of access points of a wireless local area network (WLAN) at the venue, and historical data associated with access point handovers of user devices at the venue. Using the ML model, a prediction associated with a potential handover of a user device from a first access point, of the plurality of access points, to a second access point is made based, at least in part, on mobility information associated with the user device. A device associated with the WLAN signals the user device to prepare for the potential handover based on the prediction.

### CROSS REFERENCE TO RELATED APPLICATION

This application claims priority to U.S. Provisional Application No. 63/785,815, filed Apr. 9, 2025, the entirety of which is incorporated herein by reference.

### TECHNICAL FIELD

The present disclosure relates to handovers in wireless networks.

### BACKGROUND

Handover mechanisms in wireless networks largely rely on client-side heuristics with fixed signal thresholds. These reactive approaches often result in inefficient handovers, leading to a poor user experience. Sticky Wi-Fi clients tend to remain connected to Wi-Fi access points even when a stronger cellular signal is available.

### BRIEF DESCRIPTION OF THE DRAWINGS

FIG. 1 is a block diagram illustrating an exemplary environment in which embodiments described herein may be implemented.

FIG. 2A illustrates a diagram in which a handover is predicted without telemetry information, according to an example embodiment.

FIG. 2B illustrates a diagram in which a handover is predicted based on telemetry information, according to an example embodiment.

FIG. 3 illustrates a diagram that depicts predictions points for handovers to different access points, according to an example embodiment.

FIG. 4 illustrates a diagram in which predictions for handovers to different access points are validated, according to an example embodiment.

FIG. 5 illustrates a diagram in which device classification is used to make a handover prediction, according to an example embodiment.

FIG. 6 illustrates a user interface that includes a floor map for creating a client stimulation path, according to an example embodiment.

FIG. 7 illustrates a user interface in which a client path is simulated, according to an example embodiment.

FIG. 8 illustrates a flow chart of a method of predicting a potential handover and signaling a user device to prepare for the potential handover, according to an example embodiment.

FIG. 9 is a hardware block diagram of a device that may be configured to perform the operations involved in making a handover prediction, according to an example embodiment.

### DETAILED DESCRIPTION

### Overview

In one embodiment, a method is provided for predicting a potential handover and signaling a user device to prepare for the potential handover. The method includes training a machine learning (ML) model using information associated with a layout of a venue, locations of a plurality of access points of a wireless local area network (WLAN) at the venue, and historical data associated with access point handovers of user devices at the venue. Using the ML model, a prediction associated with a potential handover of a user device from a first access point, of the plurality of access points, to a second access point is made based, at least in part, on mobility information associated with the user device. A device associated with the WLAN signals the user device to prepare for the potential handover based on the prediction.

In some embodiments, the potential handover may be a potential handover from one access point of the WLAN to another access point of the WLAN. In other embodiments, the potential handover may be a potential handover from an access point of a WLAN to an access point of another network, such as a cellular network. In these embodiments, the user device may use Wi-Fi to connect to an access point of the WLAN. When the user device leaves the Wi-Fi zone, or when the user device exits an extended service set (ESS) zone that includes a collection of access points of a larger Wi-Fi zone, the user device may potentially perform a handover to a cellular network.

### Example Embodiments

In general, the handover (HO) process is a reactive approach in which client devices are triggered to search for new access points after a wireless local area network (WLAN) signal strength associated with a current access point has dropped below a certain threshold for a period of time. By the time the handover process is triggered, the application experience has already deteriorated, and damage has already been done. The fundamental issue lies in the generic heuristics built into the client device. These heuristics do not have venue-specific awareness, such as an understanding of radio frequency (RF) characteristics at the venue, placement of access points (APs) at the venue, or awareness of exit doors, walkways, and mobility patterns where the handoffs occur. Currently, this awareness is absent in the HO process and a user device can gain this knowledge only with the aid from the access network that has this knowledge. As referred to herein, a WLAN may refer to an Institute of Electrical and Electronics Engineers (IEEE) 802.11 (any appropriate standard or variant) or Wi-Fi® network.

By integrating venue layout awareness, mobile device path trajectories, and historical mobility patterns, techniques described herein provide for moving beyond reactive handovers and developing a truly predictive system for handovers. Embodiments described herein enable a wireless network to anticipate handovers (“Handover-Imminent-In-X-Seconds” or “Handover-Imminent-In-Y-Steps”) and proactively signal these predictions to client devices as a network aid. A handover may be imminent if it is likely to occur within the next, for example, 10 seconds or 20 steps. According to some embodiments, techniques described herein generate predictions unique to a device manufacturer (e.g., “You are a device that is Type 1 with the HO Received Signal Strength Indicator (RSSI) threshold of −70 decibel-milliwatts (dBm), and so you will hit an HO event in 12 seconds” or “There is no public cellular network for the next 300 meters”). These unique signatures may be generated specific to the client device and the venue in which the client device is located. In some embodiments, the prediction is based on the client device's current position and path trajectory.

Techniques described herein provide for an artificial intelligence (AI) or machine learning (ML)-based approach in which a wireless network aids client devices in proactive handover decisions. According to embodiments, the wireless network makes handover predictions for user devices at a venue using a ML model that is trained using a layout of the venue (e.g., walkways, entry/exit doors, obstacles, radio frequency (RF) characteristics on the floor, etc.), access point (AP) location data (with or without edge AP markings), and handover patterns on the floor (including historical data of client HO behaviors with consideration to device type and make). In some embodiments, the edge access points may be marked. In other embodiments, based on the mobility patterns, the system may determine which access points are edge access points. For example, an access point may be determined to be an edge access point based on being the first access point to which user devices connect when the user devices first join a network or the last access point to which user devices connect before the user devices leave the network.

In some embodiments, a wireless network may provide a prediction signal to the client/user device when a handover is imminent. In other embodiments, the client/user device may provide its motion elements to the wireless network and request the wireless network to provide a handover prediction.

Thus, present embodiments improve the technical field of client device handovers in a wireless network by using machine learning models to predict when a potential handover of a client device from one access point to another access point within a network or a potential handover from one network to another network (e.g., a wireless wide area (WWA) Third Generation Partnership Project (3GPP) or cellular network, such as a Fifth Generation (5G) cellular network) is likely to occur. Present embodiments therefore increase the efficiency of performing handovers by incorporating venue-and device-specific awareness into the handover predictions to accurately predict when a handover in the venue is likely to occur and proactively signal to a mobile device information about the potential handover. Thus, present embodiments provide the practical application of a wireless access network that uses a machine learning model trained using venue-and device-specific awareness to predict when a handover of a mobile device from one access point in the wireless network to another access point in the wireless network or a handover of the mobile device from one wireless network to another wireless network is likely to occur and proactively signal to the wireless device information associated with the handover so the mobile device is able to prepare for and perform the handover before signal quality deteriorates.

The embodiments described herein provide an improvement to the technological field of wireless communication. Generally, when performing a handover between two access points of a wireless local area network or between an access point of a wireless local area network and a base station of a cellular network, a user device performs the handover when the signal strength of an access point to which a user device is attached is below a threshold value for a period of time. In particular, “sticky” user devices that are connected to Wi-Fi tend to remain connected to Wi-Fi access points even when a stronger cellular signal is available. Remaining connected to an access point with a low signal strength leads to inefficient handovers and results in a poor user experience. In other words, during the period of time in which the user device remains connected to an access point with a low signal strength, but before the handover to an access point with a higher signal strength has occurred, a user's wireless access may be slow and/or spotty, leading to frustration and a poor user experience.

The embodiments described herein improve the technological field of wireless communication by signaling to a user device when a predicted handover (e.g., between two access points of a local wireless network or between an access point of a local wireless network and a cellular network) is likely to occur. As described above, the handover prediction is made using a machine learning model that is trained, for example, on venue-specific information and the handover prediction is made using information associated with the venue and mobility information associated with the user device. By proactively signaling the user device about the predicted handover, the user device is able to prepare for the handover and perform the handover quicker and more efficiently, which leads to a better user experience. By implementing the techniques described herein, the handover to a new access point or to a new network (e.g., a cellular network) may be performed before the signal strength associated with a current access point has deteriorated to an unacceptable level.

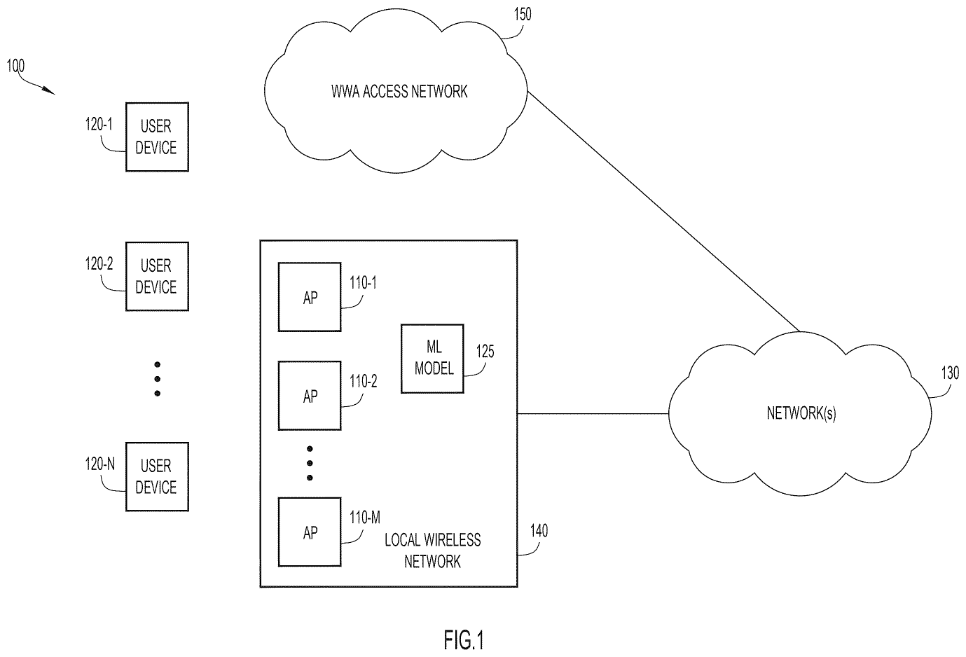

FIG. 1 is a diagram showing an environment 100 in which techniques described herein may be implemented. Environment 100 includes user devices 120-1, 120-2, . . . 120-N that may be connected to a local wireless network 140 or a wireless wide area (WWA) access network 150 to provide access to network(s) 130, such as the Internet. The local wireless network 140 includes a machine learning (ML) model 125 and access points (APs) 110-1 to 110-M that provide access to network(s) 130.

The user devices 120-1 to 120-N may be tablets, laptop computers, Smartphones, or any user device now known or hereinafter developed that can access a network, such as the Internet, using a wireless network (e.g., local wireless network 140), a wide area network, or another wireless network. In some embodiments, user devices 120-1 to 120-N may attach to an access point of a wireless network using Wi-Fi. The user devices 120-1 to 120-N may also have short-range wireless system connectivity (such as Bluetooth™ wireless system capability, ultrasound communication capability, etc.) to enable local wireless connectivity.

In other embodiments, user devices 120-1 to 120-N may be capable of accessing network(s) 130 using a cellular network, such as WWA access network 150. In some embodiments, user devices 120-1 to 120-N may access network(s) 130 using local wireless network 140 when user devices 120-1 to 120-N are in range of one of APs 110-1 to 110-M and user devices 120-1 to 120-N may access network(s) 130 using WWA access network 150 when user devices 120-1 to 120-N are not in range of one of APs 110-1 to 110-M. As described below, user devices 120-1 to 120-N may perform a handover between local wireless network 140 and WWA access network 150 (or between WWA access network 150 and local wireless network 140) based on a location of the user devices 120-1 to 120-N and a signal strength of access points for the networks. User devices 120-1 to 120-N may also be referred to herein as ‘clients’, ‘client devices’, ‘stations’, and variations thereof.

The local wireless network 140 may be, for example, a wireless local area network (WLAN) in a venue, such as a building. When user devices 120-1 to 120-N are at the venue, user devices 120-1 to 120-N may connect to an AP 110-1 to 110-M of the local wireless network 140 to access network(s) 130. APs 110-1 to 110-M may be located in different locations in a region, environment, or venue, such as on one or multiple different floors of a building. A user device 120-1 to 120-N may wirelessly connect to a particular one of the APs 110-1 to 110-M to access network(s) 130 based on the locations of the user device and the AP 110-1 to 110-M.

As a user device 120-1 to 120-N moves throughout the region or environment, a handover may be performed from one AP of the APs 110-1 to 110-M to another of the APs 110-1 to 110-M. For example, user device 120-1 may be located near AP 110-1 and may be wirelessly connected to AP 110-1 for accessing network(s) 130. User device 120-1 may move to a location closer to AP 110-2. As the signal strength associated with AP 110-1 decreases and the signal strength associated with AP 110-2 increases, a handover may occur in which user device 120-1 stops being wirelessly connected to AP 110-1 and becomes wirelessly connected to AP 110-2.

In addition, as a user device 120-1 to 120-N exits the environment and is no longer in a range of an AP of the APs 110-1 to 110-M (or a signal strength associated with APs 110-1 to 110-M is below a threshold level), the user device 120-1 to 120-N may perform a handover to a WWA access network 150. In this case, the user device 120-1 to 120-N may stop being wirelessly connected to an AP 110-1 to 110-M and may attach to a base station or access point of the WWA access network 150 to access network(s) 130.

As discussed above, conventionally, the handover process may be triggered after the signal strength (e.g., associated with AP 110-1) is below a signal strength threshold for a period of time. The conventional handover process takes a reactive approach in which the user device searches for other access points after the current link quality has deteriorated. For example, if a user device determines that the RSSI associated with a particular access point has gone below −72 dBm for five seconds, the user device may begin to search for a better access point. Therefore, user device 120-1 to 120-N may experience a deteriorated quality before the handover is performed (e.g., from AP 110-1 to AP 110-2 or from an AP 110-1 to 110-N of local wireless network 140 to a base station of a cellular network).

In particular, user devices tend to remain connected to (WLAN/Wi-Fi) APs 110-1 to 110-N even when a stronger cellular signal associated with WWA access network 150 is available. For example, when a user device 120-1 to 120-N exits the environment associated with local wireless network 140, the signal strength associated with APs 110-1 to 110-M may be lower than the signal strength associated with WWA access network 150, but the user device 120-1 to 120-N may remain connected to an AP 110-1 to 110-M for a period of time. During this period of time, the user device 120-1 to 120-N may experience a poor connection to network(s) 130, leading to a poor user experience.

According to embodiments described herein, local wireless network 140, using the ML model 125, may aid user devices 120-1 to 120-N in making handover decisions so that the user device may be prepared to make a handover to a particular AP or to a WWA access network before the signal strength associated with a current AP has deteriorated to a point in which a loss of quality of experience has occurred. Local wireless network 140 may use ML model 125 to predict a next access point for a user device 120-1 to 120-N or to predict that the user device 120-1 to 120-N will likely leave the environment served by local wireless network 140. In some embodiments, local wireless network 140 may automatically provide a prediction signal to the user devices 120-1 to 120-N when a handover is imminent without a request from the user devices 120-1 to 120-N. In other embodiments, the user devices 120-1 to 120-N may provide motion elements (e.g., location, speed, direction, etc.) to the local wireless network 140 and request that the local wireless network 140 provide a handover prediction.

Local wireless network 140 may signal one or more of user devices 120-1 to 120-N to prepare to perform a handover between access points of the local wireless network 140 or to perform a handover from the local wireless network 140 to WWA access network 150. This prediction may be based on the motion elements (e.g., speed, direction, etc.) and the current location of the user device. A model trained based on a floor map of the venue with AP layout, historical handover patterns, etc. will be able to predict the handover when given the motion elements and the location of the user device. In some embodiments, a user device 120-1 to 120-N may provide its motion elements to local wireless network 140 and ask local wireless network 140 to provide a handover prediction based on the motion elements.

Based on the prediction, user devices 120-1 to 120-N may proactively perform the handover before the signal strength has deteriorated. Proactively performing the handover decreases instances of poor user experience by minimizing or eliminating instances in which a user device 120-1 to 120-N remains connected to an access point with a low signal strength when an access point with a higher signal strength is available.

ML model 125 may be trained using a venue layout with awareness of, for example, walkways, entry/exit doors, obstacles, and the RF characteristics on the floor. ML model 125 may additionally be trained using AP location data with additional metadata with edge AP marking. ML model 125 may additionally be trained using handover patterns on the floor or in the region/environment. For example, historical data of client HO behaviors with consideration to device type and make may be used to train ML model 125. The device type may include a manufacturer or vendor of the device or hardware/software associated with the device. Different types of devices may implement different heuristics for determining when to perform a handover. For example, devices associated with vendor X (e.g., Type 1 devices) may perform a handover when a signal strength is below −72 dBM for 5 seconds and devices associated with vendor Y (e.g., Type 2 devices) may have logic that indicates that the handover is to be performed when the signal strength goes below −69 dBM for 8 seconds.

In some embodiments, the ML model 125 may learn from supervised data, in which past handover events are labeled with corresponding mobility parameters (e.g., signal degradation, device speed, direction, and movement patterns). Reinforcement learning techniques may further optimize these models. Based on the training, the ML model 125 may make predictions about potential handovers for user devices 120-1 to 120-N at a venue when provided the current location of the user devices 120-1 to 120-N at the venue and motion elements associated with user devices 120-1 to 120-N.

In some embodiments, ML model 125, which is trained based on the above elements, may continuously process incoming telemetry from the user device 120-1 to 120-N. The telemetry data may include, for example, a speed, direction, and current AP association associated with the user device 120-1 to 120-N. Using this data, the ML model 125 may generate probabilistic handover predictions. A handover prediction may estimate an amount of time or distance before a handover of a user device 120-1 to 120-N to an AP 110-1 to 110-M is expected. In addition, the prediction system may be further augmented by integrating with crowdsourced RF data for generating additional signals or fine tuning the predictions.

The predictions of the next access point are signaled to the user device 120-1 to 120-N, allowing the user device to prepare for a seamless handover. The preparation can include, for example, a user device activating the link-layer on an alternative access, performing an application handover switching to the other access point, displaying a message to the end user of an imminent connection loss, or another action. In some implementations, the predication may also be used by applications stored on a user device. For example, the user device may instruct a voice or video application to begin using a low-bit rate transmission/codec in anticipation of an imminent handover. In some embodiments, an application may be signaled to perform connection migration based on the received signal from the network (which uses the model for prediction). For example, the application may close the current connection using the Internet Protocol (IP) address of the current link and open a new connection using the IP address associated with the new link.

In some embodiments, a classifier (e.g., a random forest classifier) with structured data from venue maps, AP placements, and mobility patterns may be used for determining the handover predictions. The trained ML model 125 can generate various handover predictions based on mobility patterns and venue characteristics. The predictions customize network assistance based on venue layout, mobile device speed, mobile device direction of travel, and other considerations. Although random forests may be used for handover predictions, other models (e.g., Recurrent Neural Networks (RNNs), Long Short-Term Memories (LSTMs), etc.) that deal with time-series data may be used when processing sequential data for time-based predictions.

Based on mobility data associated with a user device, the ML model 125 may make predictions about handovers between APs 110-1 to 110-M in the local wireless network 140 or between APs 110-1 to 110-M and an access point (e.g., a radio access point, such as a base station) in WWA access network 150. In some embodiments, the ML model 125 may make an exit prediction indicating that a user device 120-1 to 120-N is likely to exit the local wireless network in the venue. For example, the prediction may state that “There is a 95% probability that a device heading toward the exit door will leave the local wireless network in 10 seconds or within 20 steps.” This prediction enables the local wireless network 140 to signal the user device/client for link-layer activation on cellular access to WWA access network 150.

In one example, assume the venue is a large building that does not receive strong cellular signals. Using the ML model 125 and mobility information associated with a user device 120-1 to 120-N, local wireless network 140 may predict that the user device 120-1 to 120-N is headed toward an exit and is likely to leave the building. Local wireless network 140 may signal the user device 120-1 to 120-N to prepare to perform a handover to WWA access network 150. Based on the signaling from local wireless network 140, user device 120-1 to 120-N may start searching for a radio access point for WWA access network 150 and start priming for application migration to WWA access network 150. Without receiving the handover prediction from local wireless network 140, user device 120-1 to 120-N may remain connected to an AP 110-1 to 110-M of local wireless network 140 even when the signal strength has deteriorated. However, by signaling to user device 120-1 to 120-N according to techniques described herein, the user device 120-1 to 120-N may prepare for the handover to WWA access network 150 and seamlessly switch to cellular access when the user device 120-1 to 120-N exits the venue. In this way, the user device 120-1 to 120-N may quickly switch to cellular access when the cellular access is available and may not experience a deterioration in access to network(s) 130.

In another embodiment, the ML model 125 may make an on-floor mobility prediction for a user device 120-1 to 120-N. For example, the prediction may state that “There is a 60% probability that a device heading toward the elevator on the third floor will perform a handoff to the second-floor access point (AP-2-5), or a 40% probability it will attach to the third-floor access point (AP-3-5).” The local wireless network 140 may transmit or signal the prediction to the user device 120-1 to 120-N. The prediction helps the user device 120-1 to 120-N optimize the state transfer from one access point to another access point for faster reassociation.

In another embodiment, the ML model 125 may make a directional movement prediction based on the movement of a user device 120-1 to 120-N. For example, the prediction may state that “There is a 70% probability that a device attached to AP-9 (first attach) at the east side entrance of Building 24/1 lobby will subsequently connect to AP-8.” Predicting directional movement allows for preemptive AP steering and faster reassociation once the handover has occurred.

In another embodiment, the ML model 125 may make a prediction when there is no client mobility telemetry data (e.g., when the user device 120-1 to 120-N is not moving or when mobile telemetry data is not available). For example, the prediction may state that “This device, when it moves, will perform a handoff to AP-1 at 70%, AP-4 at 30% probability.” The prediction may be a statistical-based prediction made without using the motion data (e.g., direction, trajectory, speed, etc.) of the user device 120-1 to 120-N. As discussed further below, in some embodiments, the prediction may be based on a time of the day. In this embodiment, the ML model 125 may have time-based clusters so that the handover prediction may change based on the time of the day. For example, using time-of-the-day predictions, it may be determined that a device attached to AP-1 at 11 AM will handoff to AP-4 at a 70% probability and to AP-2 at a 30% probability. The same device may have different probabilities for performing handovers to access points at 5 PM.

In another embodiment, the ML model 125 may make a crowdsourced RF data integration prediction based on historical mobility data associated with user devices in the venue and current data associated with user devices in venue. For example, the prediction may state that “Based on historical mobility data and crowdsourced RF signal strength, there is an 80% probability that devices leaving AP-7's coverage zone will be able to attach to a cellular network in 20 meters.” This prediction leverages real-time RF propagation data to guide optimal network transitions.

In another embodiment, the ML model 125 may make a prediction based on device-specific handover behavior. For example, the prediction may state that “You are a device that is Type 1 and attached to AP-4. Your speed and directions suggest that you are going to hit an RSSI threshold for handoff in 20 seconds.” Because RSSI thresholds may be different for different types of devices, this prediction may not be relevant to a device that is Type 2 (e.g., associated with a different manufacturer or vendor) moving on the same path trajectory and at the same speed. Using this information, handover prediction models may be built that support device-type clusters in which the prediction uses the type of the device as a key for the prediction logic.

In some embodiments, identity-based elements (e.g., indicating an identity of a user or a user device 120-1 to 120-N) are not used in the prediction model to preserve privacy. In particular, the training dataset does not use any elements that identify the user device. Pre-training is performed without identity-based clustering. Predictions are either mobility-driven (e.g., based on movement data) or statistical (e.g., based purely on historical trends), relying on aggregated trends. Even if an identifier of a user device 120-1 to 120-N or user is anonymized for identity-based clustering, the same anonymized identifier would still be utilized for prediction queries. This would allow tracking over time, defeating the purpose of anonymization. Instead, embodiments described herein aggregate mobility trends without linking the trend to a given user identifier or an anonymized identity. Pre-training data with groups of users walking together raises the statistical weight for a given handover transition in the model but does not involve identity elements. For example, the predictions would not say “You are user-X, attached to AP-1, most likely your next HO event is cellular at 65% probability.”

In some embodiments, a mobility-based prediction of a handover or a user device 120-1 to 120-N may include some personalization because the mobility elements of the user device 120-1 to 120-N may be used in the prediction query. However, the privacy issue can depend on how the user device is able to provide some information (e.g., mobility information) to the local wireless network 140 and ask for HO prediction without revealing its identity. In some embodiments, a user device 120-1 to 120-N may consent to share its location with the local wireless network 140. In these embodiments, an exchange may be performed between the user device 120-1 to 120-N and the local wireless network 140 regarding consent aspects and how the location data may be used.

Different approaches may be used for data generation, training, and simulation of the ML model 125. In some embodiments, manual training of the ML model 125 may be used. In other embodiments, such as using a deployed Vector Roaming system, manual training may not be involved. Receiving some configurations for each venue deploying the local wireless network 140 (e.g., exit doors, AP location, etc.) may be useful for training the ML model 125, but many of those elements may be derived automatically. For example, user devices 120-1 to 120-N may continuously send motion data to local wireless network 140, and the system may continuously train the ML model 125 using the motion data, which may improve prediction accuracy over time. However, if some manual data is provided, the initial (e.g., day 1) predictions may be more accurate.

The use of Vector Roaming (e.g., to determine a location of a user device 120-1 to 120-N) may involve client participation. For example, an unmodified user device 120-1 to 120-N that does not provide mobility information to local wireless network 140 cannot take advantage of the machine learning-based handover prediction capabilities of local wireless network 140. In other words, the local wireless network 140 generates predictive handover signals based on aggregated HO trends, venue awareness, AP locations, and historical mobility data, and delivers the predictive handover signals to the user devices 120-1 to 120-N. The predictive handover signals may not be delivered to a user device 120-1 to 120-N that has opted to not provide mobility information. If the user device 120-1 to 120-N is not participating, the user device 120-1 to 120-N may not receive these proactive signals and may continue to rely on its own heuristics for performing handovers.

In some embodiments, a user device 120-1 to 120-N and an AP 110-1 to 110-M may perform a capability exchange. For example, a user device 120-1 to 120-N may query the AP 110-1 to 110-M to determine whether the access point supports Vector Roaming. In one embodiment, the access point may advertise its capability for Vector Roaming. In another embodiment, the access point may respond to the client device query indicating that it supports Vector Roaming. In some embodiments, there may be extensions to IEEE 802.11 messages, such as Beacons, Association Requests, Association Responses, Access Network Query Protocol (ANQP) messages, or 902.11 Action Frames around this capability.

Without a user device's participation, several parameters or elements associated with the user device may still be inferred. For example, the local wireless network 140 may infer certain motion elements based on noting signal strength variations, association and reassociation events, dwell-time estimates, and location approximation. This inference can also be based on the coordination of the APs 110-1 to 110-M. However, these elements may not be accurate. In addition, an AP 110-1 to 110-M may identify that a user device 120-1 to 120-N is in a particular region around the access point. For example, the access point may know that a user device is on the east side and closer to a different access point.

With the user device's participation, the user device's motion elements are accurate, and, therefore, the handover predictions on the local wireless network 140 are accurate. In addition, with reinforcement learning, the accuracy of the system will improve. Over time, the ML model 125 can continue to refine the predictions by comparing predicted handover events to real handover events. For example, the ML model 125 can be tested with both synthetic and real data, using a mix of different kinds of mobile devices. The ML model 125 can be trained on one part of the data and tested on the rest. The ML model 125 can correctly predict handover events based on the training. Therefore, as long as the motion data associated with the mobile devices is accurate, the ML model 125 may be able to make reliable predictions.

In some embodiments, current association data may be used from the current data sets, floor maps, pathways, and RSSI values of the user devices from the perspective of the local wireless network 140 to predict where a handover has occurred on the floor. In other words, even though the current user devices may not be sending motion data to the local wireless network 140, the current data set, floor maps, and RSSI data may be used to infer where the handover occurred. This information may be used for generating labeled training data.

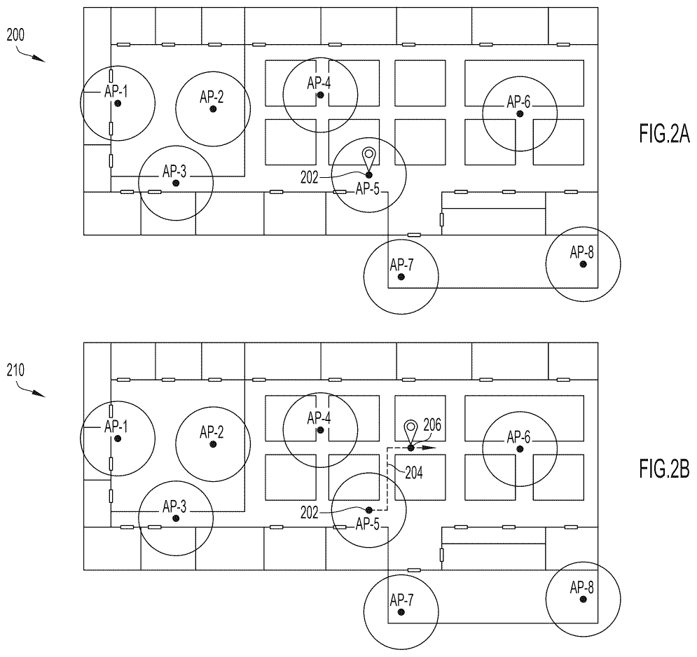

Reference is now made to FIGS. 2A and 2B. FIG. 2A is a diagram 200 illustrating an example in which the ML model 125 makes a prediction for a user device without telemetry data (e.g., speed, direction, location, etc.) and FIG. 2B is a diagram 210 illustrating an example in which the ML model 125 makes a prediction for a user device with telemetry data. When telemetry data is available that indicates path information associated with a user device, a prediction regarding when a handover associated with the user device is likely to happen is more accurate. When there is no such device path information for a user device, the handover prediction may be statistically constructed from historical data.

As illustrated in FIG. 2A, initially the user device or station (STA) is located at location 202 (e.g., position (444, 264)) and is connected to the access point AP-5. In this example, there is no telemetry data for the client device (e.g., the client device's mobility information is unavailable or the client device is stationary). As a result, the ML model 125 predicts that the optimal next access point for the user device remains AP-5.

In some embodiments, when telemetry data is not available for a client device, the prediction of the next access point may be made based on additional factors, such as a time of the day. In these embodiments, the ML model 125 may be trained with time-of-the-day as an input parameter. To train the ML model 125 with time-of-the-day parameters, time elements are first retained in the training dataset. Next, time-based statistical scores are assigned. The ML model 125 learns and assigns statistical weights to different handover transitions with time as a parameter.

As an example of time-based handover predictions, if 70% of the handover events occur from AP-4 to AP-8 between 9 AM and 10 AM and 30% of the handover events occur from AP-4 to AP-6 around the same time, the ML model 125 assigns higher weight to the first transition (e.g., AP-4 to AP-8) for that time window. The same handover predictions may have different statistical scores at a different time.

The ML model 125, instead of building a single, fixed probability model, builds handover event clusters that are partitioned by time. This allows the ML model 125 to perform predictions with time-of-the-day as a consideration. For example, the ML model 125 may predict that from 9 AM to 10 AM there is a 60% chance that a handover from AP-4 to AP-5 will occur for a particular mobile device (e.g., 9 AM-10 AM: AP-4→AP-5: 60%). At lunchtime, from 12 PM to 1 PM, there is an 80% chance that a handover from AP-8 to AP-9 (e.g., toward the cafeteria) will occur for the mobile device (e.g., 12 PM to 1 PM: AP-8→AP-9 (Towards Cafeteria): 80%). Between 5 PM and 6 PM, there is a 95% chance that the mobile device will exit the building and begin accessing a cellular network (e.g., 5 PM-6 PM: AP-4→Out of ESS Zone: 95%).

When a prediction request comes, the current time of the day may be identified and the pre-trained probabilities for the corresponding time window may be determined. As a result, the likelihood of the occurrence of a given handover prediction (or its probabilistic score) changes based on the time of the day. Factoring in the time of the day works well for a case in which a station's current mobility elements (e.g., speed, direction, etc.) are not provided or when the device is stationary (e.g., a user has been sitting in a conference room for the last 4 hours). In such cases, the handover prediction may be a generic, weight-based statistical score for a given handover transition. In that approach, the time of the day consideration fits nicely, and the statistical score changes based on time. Using this approach involves the pre-trained model to include a timestamp in the event dataset.

However, as described below, for a mobility-based prediction, the predictions may be largely driven by the location of the station at the venue and the direction and speed of the station. In this case, a higher score is given to a station's mobility-based prediction, and the time of the day may not be a consideration.

FIG. 2B illustrates an example in which mobility data is available for a user device. In FIG. 2B, as shown in the map, the client device that was originally at location 202 begins moving along a path 204, reaches location 206 (e.g., position (526, 191)), and is connected to AP-5. As the client device continues moving away from AP-5 toward AP-6, the ML model 125 predicts AP-6 as the target access point for the client device.

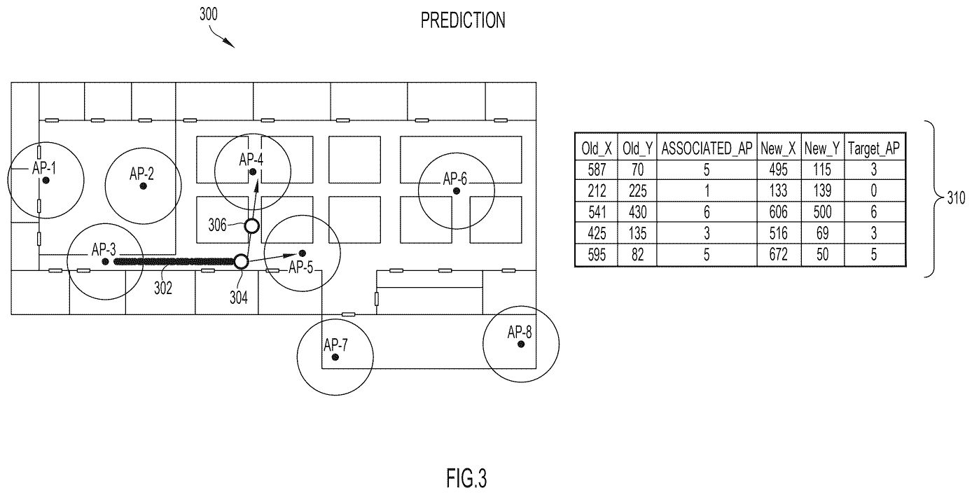

Reference is now made to FIG. 3. FIG. 3 is a diagram 300 illustrating the ML model 125 making a prediction for the next access point based on different pathways in an environment or floor. In this example, the ML model 125 uses a client device's path, speed, and historical mobility patterns of user devices on the floor to make the handover prediction.

As illustrated in FIG. 3, the user device is moving on path 302 and a prediction is made for the next access point to which the user device will wirelessly connect. The prediction may be made based on several factors including (but not limited to) the current location of the user device, the last five location points of the user device (as illustrated in chart 310), and the current associated AP. As the user device moves and reaches point 304, the ML model 125 predicts AP-5 as the next access point for the user device. However, if the user device turns and reaches point 306, the ML model 125 predicts AP-4 as the next access point for the user device. Using mobility information associated with the user device gives the most accurate prediction for the next access point.

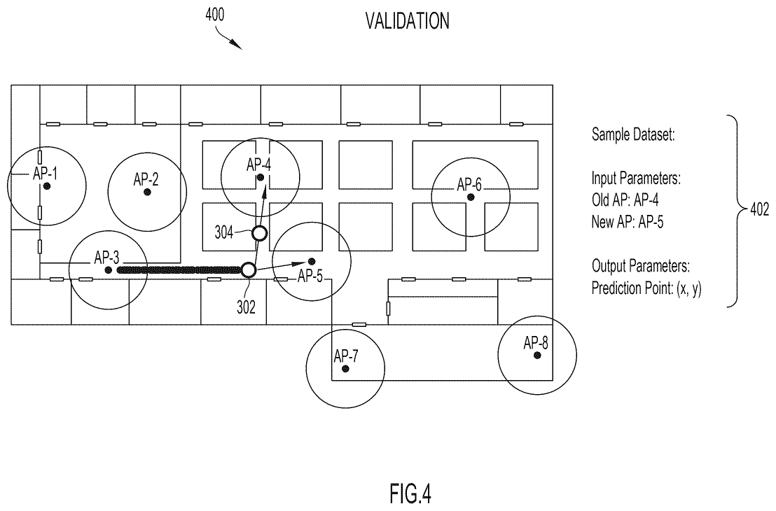

Reference is now made to FIG. 4. FIG. 4 is a diagram illustrating a user interface 400 for performing a validation of the predictions made in the example illustrated in FIG. 3. To perform the validation, a dataset 402 is collected for the walkway by running a simulation and storing the data points. Specifically, the first instance where the target AP differs from the associated AP is collected and that point is recorded. In this example, the sample data set includes: 1. Input Parameters-Old AP: AP-4 and New AP: AP-5, and 2. Output Parameters-Prediction Point: (x, y). In this example, as described above with respect to FIG. 3, point 304 is the prediction point for AP-5 and point 306 is the prediction point for AP-4. The handoff point can be determined based on the comparison of RSSI values at the point. The threshold of X range is assumed. If the user device moves within the X range, the associated AP can be changed, indicating that a handoff has occurred.

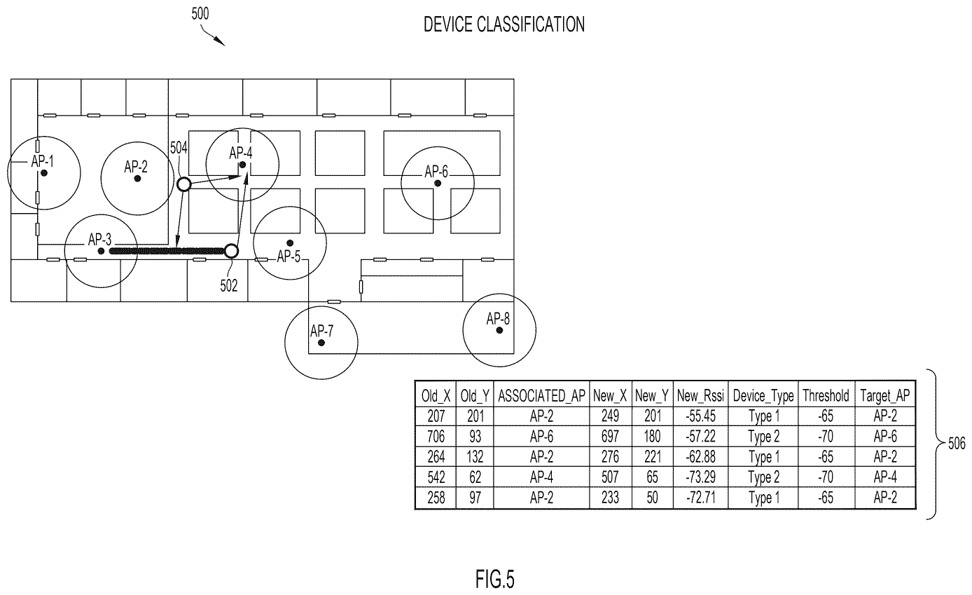

Reference is now made to FIG. 5. FIG. 5 is a diagram 500 illustrating a scenario in which the ML model 125 additionally uses the parameters “device type” and “threshold” when making a prediction for the next access point. Different device types (e.g., type of device, brand of device, etc.) may use different threshold RSSI levels when determining when or if to perform a handover from one access point to another access point. In this scenario, for each device type, a specific threshold (e.g., RSSI threshold) is set. As illustrated in sample dataset 506, a device of a first device type (Type 1) (e.g., manufactured by a first manufacturer) may have an RSSI threshold of −65 dBm and a device of a second device type (Type 2) (e.g., manufactured by a second manufacturer) may have an RSSI threshold of −70 dBm. If a user device moves beyond the set threshold for the current access point, a target AP will be determined based on the factors described above (e.g., current location, previous location points, speed, etc.). Points 502 and 504 illustrate example handoff points for AP-5 for different types of user devices based on different thresholds associated with the different types of user devices.

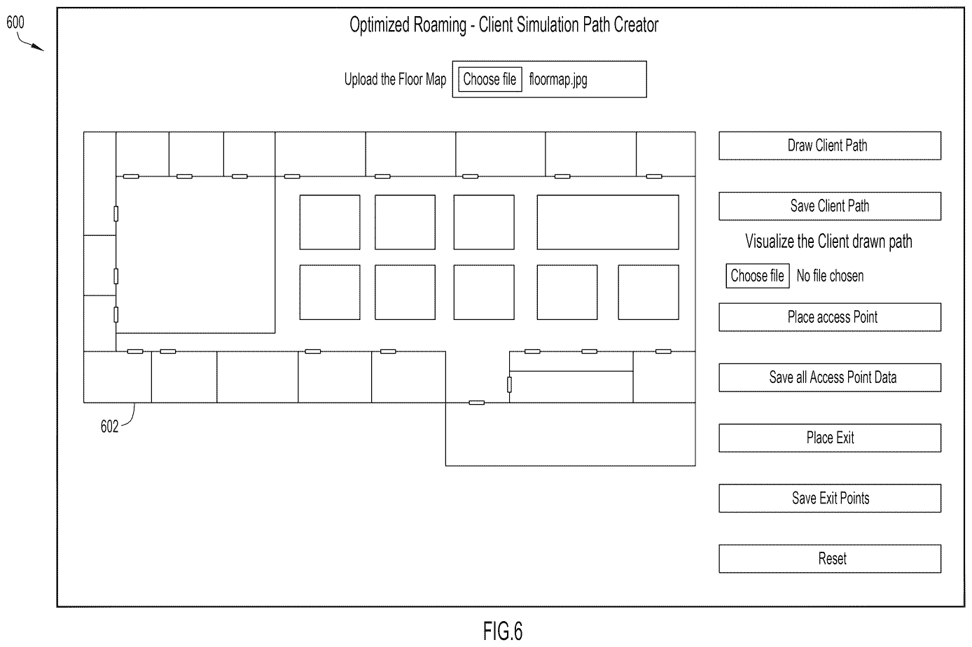

Reference is now made to FIG. 6. FIG. 6 illustrates a user interface 600 for creating a simulation of a path of a user device. As illustrated in FIG. 6, a floor map 602 of a venue associated with local wireless network 140 is uploaded to a simulation program. The floor map 602 may include, for example, walkways, workstations, obstacles, conference rooms, lobbies, pantries/kitchens, exits, etc. Floor map 602 may additionally include dimensions associated with different areas of the venue. For example, the floor map 602 may indicate how long and how wide a walkway is or may indicate a size of different workstations or rooms/areas in the venue. When the floor map 602 has been uploaded to the simulation program, the floor map 602 may be labeled with data points. In some embodiments, the floor map 602 may be used to train ML model 125 for making predictions about handovers in the venue associated with the floor map.

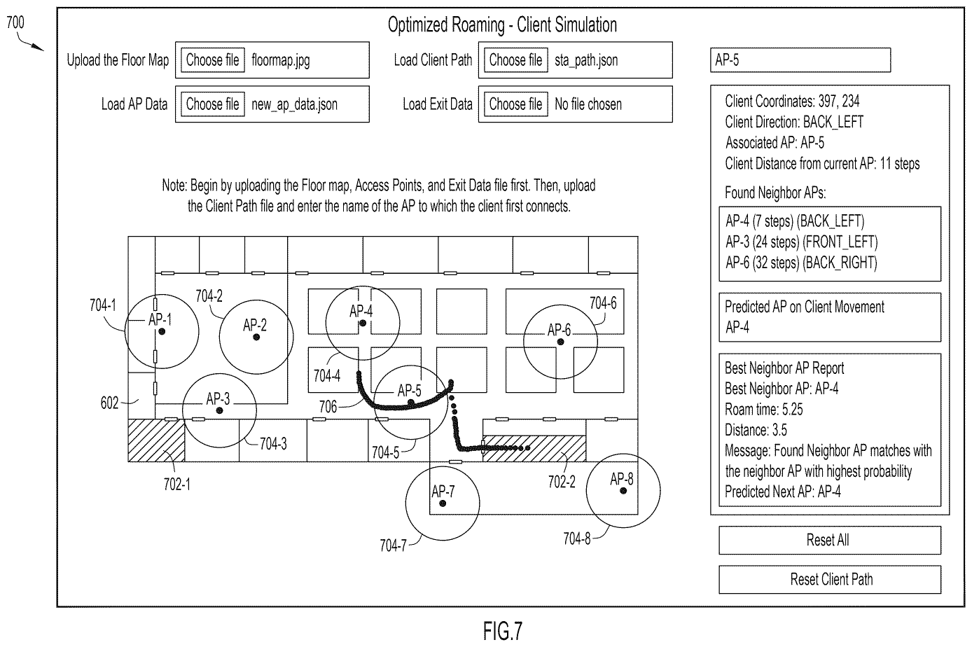

Reference is now made to FIG. 7. FIG. 7 illustrates another user interface 700 that may be used for simulating the path of a user device. As illustrated in FIG. 7, floor map 602 has been labeled with data points, such as entry/exit locations 702-1 and 702-2 and access points 704-1, 704-2, 704-3, 704-4, 704-5, 704-6, 704-7, and 704-8. Entry/exit locations may include, for example, stairs, elevators, doors, etc. In addition to labeling the access points 704-1 to 704-8, edge access points that indicate the edge of the venue may be labeled. The data points may be used for performing handover simulations.

In some embodiments, the data points may be used to train the ML model 125 for the particular venue. Because each venue may be different (e.g., have a different layout, different data points, etc.), the ML model 125 trained for a particular venue is able to determine handover predictions for the particular venue. However, for a different venue, the ML model 125 is trained differently using different parameters (e.g., venue layout and data points) for the different venue. By training the ML model 125 for a specific venue, embodiments described herein provide the advantage of making accurate handover predictions so that user devices 120-1 to 120-N are able to prepare for handovers and perform the handover before a loss of quality of experience due to a weak access point signal strength has occurred.

As illustrated in FIG. 7, a client device path 706 has been added to the floor map 602. The client device path 706 may include mobility information associated with the client device, such as location, direction being traveled, speed, trajectory, etc. A simulation has been performed to determine a predicted access point (e.g., AP-4) for performing a handover based on the client movement, client coordinates (e.g., 397, 234)), client direction (e.g., BACK_LEFT), associated AP (e.g., AP-5), client distance from the current AP (e.g., 11 steps), and neighboring APs (e.g., AP-4, AP-3, and AP-6).

Because ML model 125 has been trained using the information associated with the venue (e.g., layout, data points, etc.) and information associated with past handovers at the venue, ML model 125 is able to accurately predict the next access point within a local wireless network to which a user device will connect or that the user device is exiting a venue and will connect to a cellular network. Based on the prediction, the user device is able to prepare for a handover to another access point or to a cellular network, which leads to a higher quality of experience for users.

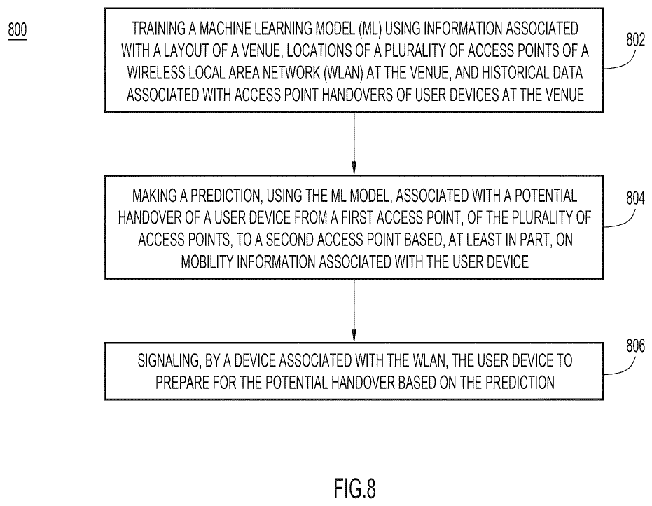

Reference is now made to FIG. 8. FIG. 8 is flow chart of a method 800 of predicting a potential handover and signaling a user device to prepare for the potential handover. Method 800 may be performed, for example, by local wireless network 140 (e.g. APs 110-1 to 110-M, ML model 125, and additional devices) in conjunction with user devices 120-1 to 120-N.

At 802, a machine learning (ML) model is trained using information associated with a layout of a venue, locations of a plurality of access points of a wireless local network (WLAN) at the venue, and historical data associated with access point handovers of user devices at the venue. For example, the ML model may be trained using a layout of the venue and data points (e.g., walkways/pathways, exit/entry locations, obstacles, etc.), historic mobility patterns of user devices within the venue, placement of access points and location data associated with the access points, edge access point markings, historical handover information associated with access point handovers of user devices in the venue, and additional information.

At 804, the ML model is used to make a prediction associated with a potential handover of a user device from a first access point, of the plurality of access points, to a second access point based, at least in part on mobility information associated with the user device. For example, based on the mobility information (e.g., location, direction, speed, etc.), a prediction associated with a potential handover may be made using the ML model. In one embodiment, the potential handover may be a handover between access points in the WLAN. In another embodiment, the potential handover may be a handover between an access point in the WLAN and a wireless wide area (WWA) access network.

At 806, a device associated with the WLAN signals the user device to prepare for the potential handover based on the prediction. Signaling the user device may include providing information associated with the potential handover (e.g., a likelihood of the handover occurring, information about when the potential handover is likely to occur, information about a new access point or network to which the user device is likely to connect, etc.) to the user device. The user device may prepare for the handover by, for example, performing actions to optimize the state transfer to a new access point for faster reassociation, perform link-layer activation for a cellular network, perform a search for a signal associated with a cellular network, perform preemptive AP steering, etc.

In summary, embodiments described herein provide for using a machine learning model to predict venue and device-specific handovers, moving beyond static threshold-based heuristics. The handover prediction model is trained with environmental awareness. In particular, a floor map with all the key structural elements (e.g., entry and exit doors, obstacles, pathways and historical mobility patterns, AP placement and location data, edge AP marking, etc.) are inputted to the ML model. The predictions may be generated with or without client device specific considerations. For a client device with no speed or path awareness, the predictions are based on a statistical score. For a client device with awareness to client telemetry (e.g., speed, direction, approximate location, etc.), the generated signal is specific to the station. In some embodiments, vendor-specific handover behaviors, such as differences in handover logic between devices of different brands, may be factored in the training of the ML model and the predictions made by the ML model. In some embodiments, handover predictions may be refined by integrating crowdsource RF data, capturing variations in network performance unique to specific venue surroundings.

Current handover techniques rely on fixed signal thresholds for handover decisions, which may result poor user experiences in various handover situations. A purely statistical approach relies on historical trends and provides predictions based on past patterns. For example, if 70% of the time, a user goes to work at 9 AM, a statistical model will predict that the user will do the same each workday. But the user may not go to work each workday. A purely statistical model will assume a usual pattern and may make an incorrect prediction. According to the embodiments described herein, an ML approach is provided that uses motion elements. As a result, the predictions are much more accurate than using a purely statistical approach. Also, unlike the statistical model, the model adapts over time with more data, improving its accuracy and proving an improvement to the technological field of wireless communication.

According to the embodiments described herein, venue awareness is incorporated into handover predictions. In particular, the ML model is trained using venue layout, AP locations data, and historical mobility patterns. The model learns from past handover events and, based on aggregated handover trends, provides handover predictions. The model continuously refines the predictions over time, using reinforcement learning techniques.

The ML model supports two modes of prediction: mobility-based (when there is client motion data), and statistical-based (when mobility data is absent). For mobility-based prediction, the model uses the motion elements (e.g., speed, direction, and trajectory) of the station for the prediction. For the statistical-based approach, the model falls back to predictions based on historical patterns.

According to the embodiments described herein, time-based HO clusters may be built for the venue. The ML model, instead of building a single fixed probability model, may build HO event clusters partitioned by time. This allows handover predictions to be performed using time-of-the-day parameters.

The ML model does not train using user/device identifiers, and, instead, trains on aggregated mobility patterns without linking data to specific clients. However, in some embodiments, the model can build HO clusters on an anonymous user basis. When performing a query, the anonymous user identifier will have presented for the prediction.

Different types of devices (e.g., devices associated with different manufacturers or vendors) may have unique handover behaviors due to varying signal strength thresholds and vendor specific heuristics. The ML model accounts for this by training on historical handover data categorized by device type. This allows the model to use device classification in the prediction.

The ML model, using crowd source network signal data outside a local wireless network, can predict granular HO predictions when exiting the local wireless network. For example, the ML model can predict “ESS Exit in 10 seconds; No cell signal for 250 meters.”

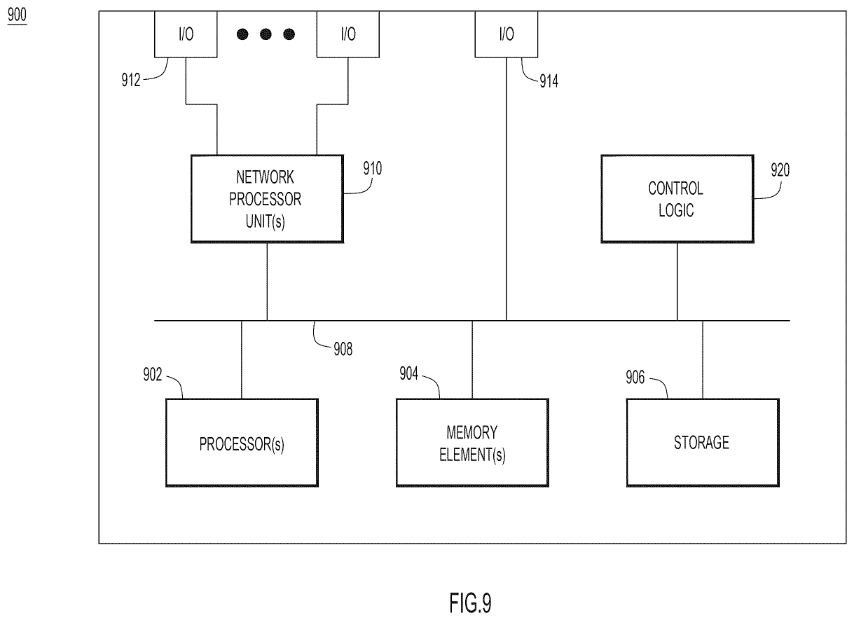

Referring to FIG. 9, FIG. 9 illustrates a hardware block diagram of a computing/computer device 900 that may perform functions of a device associated with operations discussed herein in connection with the techniques depicted in FIGS. 1, 2A, 2B, and 3-8. In various embodiments, a computing device, such as computing device 900 or any combination of computing devices 900, may be configured as any devices as discussed for the techniques depicted in connection with FIGS. 1, 2A, 2B, and 3-8 in order to perform operations of the various techniques discussed herein.

In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. This may be the case, in particular, when the computing device 900 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, particularly when the computing device 900 serves as a user device as described herein.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a method is provided. The method includes training a machine learning (ML) model using information associated with a layout of a venue, locations of a plurality of access points of a wireless local area network (WLAN) at the venue, and historical data associated with access point handovers of user devices at the venue; making a prediction, using the ML model, associated with a potential handover of a user device from a first access point, of the plurality of access points, to a second access point based, at least in part, on mobility information associated with the user device; and signaling, by a device associated with the WLAN, the user device to prepare for the potential handover based on the prediction.

In one example, signaling the user device includes transmitting, to the user device, a probability of the potential handover occurring. In another example, signaling the user device includes transmitting, to the user device, a predicted amount of time before the potential handover occurs. In another example, training the ML model further includes training the ML model using device properties of different manufacturers of the user devices, and wherein making the prediction includes making the prediction based on a manufacturer of the user device.

In another example, training the ML model further includes training the ML model using information associated with previous handoff events, and wherein the ML model continuously refines predictions over time using reinforcement learning techniques based on handover events. In another example, training the ML model further includes training the ML model using radio frequency (RF) data associated with the user devices, the RF data indicating variations in a performance of the WLAN based on parameters of the venue.

In another example, the second access point is an access point of the plurality of access points of the WLAN. In another example, the second access point is a radio access point of a wireless wide area (WWA) access network. In another example, making the prediction further includes: receiving, from the user device, a request for a handover prediction, the request including the mobility information; and making the prediction based on receiving the request. In another example, signaling the user device includes: determining that the potential handover is imminent; and proactively signaling the user device based on determining that the potential handover is imminent.

In another form, a system is provided that includes a memory storing instructions; and one or more processors, wherein the one or more processors are configured to execute the instructions to perform operations including: training a machine learning (ML) model using information associated with a layout of a venue, locations of a plurality of access points of a wireless local area network (WLAN) at the venue, and historical data associated with access point handovers of user devices at the venue; making a prediction, using the ML model, associated with a potential handover of a user device from a first access point, of the plurality of access points, to a second access point based, at least in part, on mobility information associated with the user device; and signaling the user device to prepare for the potential handover based on the prediction.

In yet another form, one or more non-transitory computer readable storage media encoded with instructions are provided that, when executed by a processor of a device associated with a wireless local area network (WLAN), cause the processor to execute a method including: training a machine learning (ML) model using information associated with a layout of a venue, locations of a plurality of access points of the WLAN at the venue, and historical data associated with access point handovers of user devices at the venue; making a prediction, using the ML model, associated with a potential handover of a user device from a first access point, of the plurality of access points, to a second access point based, at least in part, on mobility information associated with the user device; and signaling the user device to prepare for the potential handover based on the prediction.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 902.11 (e.g., Wi-Fi®/Wi-Fi 6®), IEEE 902.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
training a machine learning (ML) model using information associated with a layout of a venue, locations of a plurality of access points of a wireless local area network (WLAN) at the venue, and historical data associated with access point handovers of user devices at the venue;
making a prediction, using the ML model, associated with a potential handover of a user device from a first access point, of the plurality of access points, to a second access point based, at least in part, on mobility information associated with the user device; and
signaling, by a device associated with the WLAN, the user device to prepare for the potential handover based on the prediction.

2. The method of claim 1, wherein signaling the user device includes transmitting, to the user device, a probability of the potential handover occurring.

3. The method of claim 1, wherein signaling the user device includes transmitting, to the user device, a predicted amount of time before the potential handover occurs.

4. The method of claim 1, wherein training the ML model further includes training the ML model using device properties of different manufacturers of the user devices, and wherein making the prediction includes making the prediction based on a manufacturer of the user device.

5. The method of claim 1, wherein training the ML model further comprises training the ML model using information associated with previous handoff events, and wherein the ML model continuously refines predictions over time using reinforcement learning techniques based on handover events.

6. The method of claim 1, wherein training the ML model further comprises training the ML model using radio frequency (RF) data associated with the user devices, the RF data indicating variations in a performance of the WLAN based on parameters of the venue.

7. The method of claim 1, wherein the second access point is an access point of the plurality of access points of the WLAN.

8. The method of claim 1, wherein the second access point is a radio access point of a wireless wide area (WWA) access network.

9. The method of claim 1, wherein making the prediction further comprises:
receiving, from the user device, a request for a handover prediction, the request including the mobility information; and
making the prediction based on receiving the request.

10. The method of claim 1, wherein signaling the user device comprises:
determining that the potential handover is imminent; and
proactively signaling the user device based on determining that the potential handover is imminent.

11. A system comprising:
a memory storing instructions; and
one or more processors, wherein the one or more processors are configured to execute the instructions to perform operations comprising:
training a machine learning (ML) model using information associated with a layout of a venue, locations of a plurality of access points of a wireless local area network (WLAN) at the venue, and historical data associated with access point handovers of user devices at the venue;
making a prediction, using the ML model, associated with a potential handover of a user device from a first access point, of the plurality of access points, to a second access point based, at least in part, on mobility information associated with the user device; and
signaling the user device to prepare for the potential handover based on the prediction.

12. The system of claim 11, wherein the one or more processors are configured to perform the operation of signaling the user device by transmitting, to the user device, a probability of the potential handover occurring or a predicted amount of time before the potential handover occurs.

13. The system of claim 11, wherein the one or more processors are configured to perform the operation of training the ML model by training the ML model using device properties of different manufacturers of the user devices, and wherein making the prediction includes making the prediction based on a manufacturer of the user device.

14. The system of claim 11, wherein the one or more processors are configured to perform the operation of training the ML model by training the ML model using information associated with previous handoff events, and wherein the ML model continuously refines predictions over time using reinforcement learning techniques based on handover events.

15. The system of claim 11, wherein the one or more processors are configured to perform the operation of training the ML model by training the ML model using radio frequency (RF) data associated with the user devices, the RF data indicating variations in a performance of the WLAN based on parameters of the venue.

16. The system of claim 11, wherein the second access point is an access point of the plurality of access points of the WLAN.

17. The system of claim 11, wherein the second access point is a radio access point of a wireless wide area (WWA) access network.

18. One or more non-transitory computer readable storage media encoded with instructions that, when executed by a processor of a device associated with a wireless local area network (WLAN), cause the processor to execute a method comprising:
training a machine learning (ML) model using information associated with a layout of a venue, locations of a plurality of access points of the WLAN at the venue, and historical data associated with access point handovers of user devices at the venue;
making a prediction, using the ML model, associated with a potential handover of a user device from a first access point, of the plurality of access points, to a second access point based, at least in part, on mobility information associated with the user device; and
signaling the user device to prepare for the potential handover based on the prediction.

19. The one or more non-transitory computer readable storage media of claim 18, wherein signaling the user device includes transmitting, to the user device, a probability of the potential handover occurring or a predicted amount of time before the potential handover occurs.

20. The one or more non-transitory computer readable storage media of claim 18, wherein training the ML model further includes training the ML model using device properties of different manufacturers of the user devices, and wherein making the prediction includes making the prediction based on a manufacturer of the user device.
